(19) United States
(12) Patent Application Publication
(10) Pub. No.: US 2022/0036432 A1
(43) Pub. Date: Feb. 3, 2022

(54) Efficient Shopping

(71) Applicant: Alain Beltran, Miami, FL (US)

(72) Inventor: Alain Beltran, Miami, FL (US)

(21) Appl. No.: 16/943,945

(22) Filed: Jul. 30, 2020

(51) Int. Cl. G06Q 30/06; G06Q 30/02; G06K 7/14; G06N 5/02

(52) U.S. Cl. CPC G06Q 30/0633; G06Q 30/0206; G06Q 30/0205; G06Q 30/0631; G06Q 10/087; G06K 7/1413; G06K 7/1417; G06N 5/02; G06Q 30/0605

(57) ABSTRACT

A process for selecting and efficient retailer to purchase goods, such as groceries, includes generating a list of multiple items to be purchased from any of several optional retailers. The system gathers publicly available pricing information to calculate the total cost to purchase all goods at each of the selected retailers. The system allows the user to compare the total cost of purchasing all the goods out any individual retailer with the location of that retailer. The shopper can then elect to shop a particular retailer based on the convenience of their location and the cost to by all items on the list. This takes into account the value of the shoppers the time as well as the cost of the individual items purchased.

### CROSS-REFERENCES TO RELATED APPLICATIONS

None.

### STATEMENT REGARDING FEDERAL SPONSORED RESEARCH OR DEVELOPMENT

None.

### NAMES OF PARTIES TO A JOINT RESEARCH AGREEMENT

None.

### REFERENCE TO A “SEQUENCE LISTING”, A TABLE, OR A COMPUTER PROGRAM LISTING APPENDIX SUBMITTED ON COMPACT DISC AND INCORPORATION-BY-REFERENCE OF THE MATERIAL ON THE COMPACT DISCLOSURE

None.

### STATEMENT REGARDING PRIOR DISCLOSURES BY AN INVENTOR OR JOINT INVENTOR

None.

### BACKGROUND OF THE INVENTION

### 1. Field of the Invention

The present invention relates to portable electronic device applications, and more particularly, to an application to make shopping more efficient and cost effective.

2. Description of Related Art Including Information Disclosed Under 37 CFR 1.97 and 37 CFR 1.98

Several designs for shopping applications have been designed in the past. None of them, however, shops an entire shopping list at multiple retailers to obtain a total price to purchase all the goods and also compares the locations of the retailer relative to the user to aid the user to determine where to shop considering the location of the retailer and the savings provided by the retailer.

Applicant believes that the closest prior art corresponds to several known shopping systems that search several retailers for the best price on a singular article. However, it differs from the present invention because no known prior art shops an entire shopping list for the overall price to purchase all listed goods and compares those retailers' physical locations that allow the shopper to make a better, not necessarily cheaper, buying decision. The present invention lets a shopper decide whether to spend a few dollars more and shop at a more convenient location.

Other patents describing the closest subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### BRIEF SUMMARY OF THE INVENTION

It is one of the main objects of the present invention to provide a system to help a shopper to factor in the location of a retailer along with the overall cost for an entire shopping list.

It is another object of this invention to provide a system that shows a shopper a price difference between retailers relative to the location of that retailer.

It is still another object of the present invention to provide a way for shoppers to capitalize on their time value relative to the cost to acquire an entire shopping list.

It is yet another object of this invention to provide such a software device and related processes that is inexpensive to manufacture and maintain while retaining its effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING

With the above and other related objects in view, the invention exists in the details of construction and combination of parts as will be more fully understood from the following description, when read in conjunction with the accompanying drawings in which:

FIG. 1 shows a plan view of an example of a user interface.

FIG. 2 shows a flowchart example of parts of the process, some of which are optional.

FIG. 3 shows a flowchart example of parts of the process, some of which are optional

FIG. 4 shows a plan view of an example of a user interface.

### J. DETAILED DESCRIPTION OF THE INVENTION

While this invention may be embodied in many different forms, there are described in detail herein specific embodiments of the invention. This description is exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of use is sometimes referred to as the device, the invention, the software, the app, the application, the process, the efficient shopping, the system, the machine or other similar terms.

These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

In one embodiment of the present invention a software application is provided to aid a shopper in determining the most appropriate (or efficient) place for them to purchase a list of products. An example used in this specification is grocery shopping, however, any type of retail shopping would equally be applicable. For example, the system would be well-suited to shopping for clothes, hardware or any other retail shopping where multiple products are bought from a single retailer. Any use of a grocery example is intended to include any retail shopping.

Following on the grocery example, a user enters in a shopping list of articles that they desire to purchase. The system uses GPS coordinates provided by a mobile device upon which the system is running or may be manually entered and by the user. The system then compiles the cost to purchase the entire shopping list at all of several possible retailers. The user then has the ability to see the cost to by all the items on the shopping list at each of the retailers and can then make an informed decision on which retailer to shop at, not only based on the absolute cost of the goods on the list but also the convenience of the location of a particular retailer relative to the shopper.

For example, a location near the user's work or home may be a little more expensive for a particular list but may be far more convenient. The user then weighs whether they may prefer to spend a little bit more but to save time by shopping at a convenient location. It may be well worth it to a user to spend a few more dollars but save time and expense traveling to a location where the list may be purchased more cheaply. On the other hand, a user may choose to go to a retailer with the absolute lowest cost and the system can help direct them to that location.

The system may also include optional features such as the ability to clip and save coupons for potential retailers and for potential products. These may be store coupons or manufacturer coupons that can reduce the cost for a user as well as providing more options of where to buy. The system optionally may also include a suggestion feature that may encourage a shopper to purchase a healthier option. For example, if double chocolate chip ice cream is on the list the system may suggest a low fat, healthier option.

An application programming interface (API) is a computing interface which defines interactions between multiple other pieces of software. It is a way to organize and share data between different computing platforms. For example, a grocery store may provide information about products it carries, such as costs, availability or special offers related to the product in a database. Similarly, nutritional information for a wide variety of products and recipes may also be stored in databases. An API may be used to search, retrieve and present information for manipulation and use by a retail shopping application such as the present invention.

An individual store or chain of stores may update their data sets accessible by the API continually to make sure the information is current. Similarly, government agencies such as the United States Department of Agriculture may also maintain current nutritional information for food products. Yet other third-party databases such as recipe repositories may maintain information that is accessible to the present app through an API.

The term API includes the databases, underlying information and systems and structure to maintain an up to date body of information available the application.

Referring now to the drawings, where the present invention is generally referred to with numeral 10, it can be observed that it basically includes a map 12, a retailer 14, a list 16, controls 18, process steps 20-47, a button 49, a button 50, a button 51, a search bar 52, a search result 53, options 54, options 55, add/remove 56, a list 57, coupons 58, a flag 59, an advertisement 60, a button 61, a button 62 and a button 63.

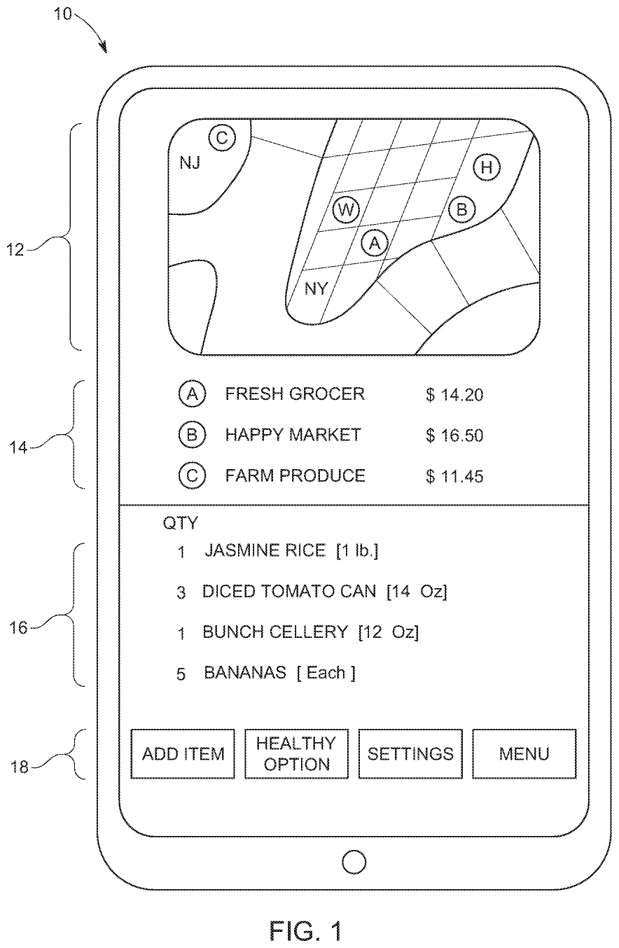

FIG. 1 shows an example of a user interface of the application. the content and configuration is merely exemplary and not intended to be a depiction of how any particular version of the application must actually be configured. Instead, the drawings are provided to provide a visual example of some core and some optional features of the system in a readily understood format.

In this example, the upper part of the display is a map 12. On the map are located example retailers A, B and C as well as a geographical flag W for work and H for home. Other user generated flags may be used for locations of interest. Generally, these flags indicate where a user is likely to travel on a periodic basis. A person will often travel daily between work and home. The map may then show retailers along the route.

A user may add additional flags to other relevant places as needed. For example, someone who brings groceries to an elderly friend may also flag the location of that elderly friend. Or, if there are other locations where the user frequents and may want to analyze retailers nearby those may also be added. For example, a fitness center, a school, a day care or any other location where the user may find herself. These visual markers on the map 12 aid the user in determining at which retailers may be the easiest for them to shop.

Continuing the example in FIG. 1, the retailers are listed in the section of retailers 14. Each of these three exemplary retailers are plotted on the map 12. For each retailer the total cost of the shopping list is also provided. In this example, the Happy Market be may be the most expensive but it is also very close to the user's home H. The user may elect to spend a few more dollars for the convenience of shopping near their home H.

On the other hand, the user may see that a short jaunt across the bridge into New Jersey to the Farm Produce C may save them several dollars. The user can then decide whether the cost of tolls, fuel and time spent to travel to the farm produce C is worth it to them or whether they can avoid the ancillary costs and additional time needed by selecting another retailer.

The user can specify a detailed shopping list 16 including the type of product, the brand, the size and any specific varieties listed along with the quantity of each. It is from this list that the database of grocery store prices and availability is compiled. This list of goods to purchase is freely editable by the user.

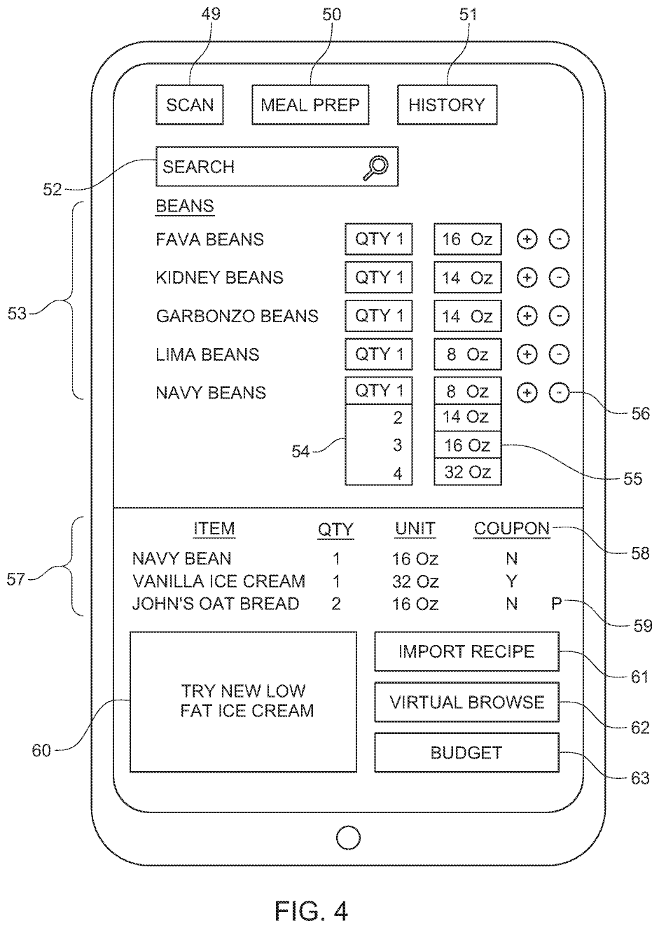

FIG. 4 shows an example of a part of the system where the user can specify the shopping list. The user may enter a search term in search box 52 for a specific product. In this example, the user searched for beans and a result of several types of available beans appeared in the search results 53.

In this example the user is interested in adding navy beans to their shopping cart. The user selected a quantity of one from the options 54 box and then selected a 16 ounce size in the options box 55. Once the quantity and size are selected the user presses the plus button from the add/remove 56 control. The item is then added to the shopping list 57.

Continuing on the example in FIG. 4, the user has the option to perform a scan 49. The user could scan the bar-code of products at home they are running low on to add to the shopping list. Or, they may scan printed coupons or a scan a code, such as a QR or bar-code to import a list from another source.

The meal prep 50 button is optionally provided to aid the user in ensuring a complete shopping list. For example, instead of shopping for individual items, a user may press meal prep 52 enter in the name of the dish. A user may want to bake a cake and by entering cake into the meal prep 50 feature the system may auto populate the shopping list with the ingredients needed to make a cake. In this example, the vanilla, eggs, flour and frosting may be automatically put onto the list 57 without having to add ingredients individually.

A button for a history 51 may also optionally be provided. The historical list of items shopped for may be presented to the user so that repeat purchases of the same product may be easily made. Many shoppers will continue to by the same brands and sizes of products periodically. This allows a user to quickly include things they purchased in the past for replenishment.

In the shopping list 57 items may be readily added or removed. The availability of a discount may be indicated in a coupon 58 column. As shown on the example of 54 the vanilla ice cream may have a discount available.

A flag 59 near a particular list 57 entry may indicate to a user that additional information is available belt is product. For example, if a particular product is not available at one of the selected retailers 14 the total cost to purchase products at a retailer may be skewed. The user may then opt to remove that item from the list or to go to a retailer that has the product in stock or to opt to exclude that item from the list and save for a future shopping list.

An ad 60 may optionally be provided. In this case, the user has added vanilla ice cream to the list 57. The system then may provide an ad for a competitor or a discount. In the example in FIG. 4, the ad 60 may also be a push for a healthier option. Suggesting that the user try a new low-fat ice cream instead of the vanilla ice cream on the list to shape a user's buying habits.

Another optional feature is in import recipe button 61. The user can search for a recipe from a third-party source. For example, a cooking show or famous chef may publish a recipe. The user may search for that recipe and import directly into the shopping list 57. The import recipe button 61 may be used in combination with the scan button 49 as described above.

The user may also have the option to virtually browse the shelves of a specific physical store or a digital rendition of a typical retail store by pressing the button 62 to virtually browse. With this feature the system displays a virtual walk through tour of some or all of a retail establishment so the user can see the stocked shelves to help make a decision on which products to add to their list 57 for purchase. This makes the experience similar to the shopper who goes to a grocery store and wanders the aisles without a written list and selects items as they encounter them.

Optionally, the system includes a budget feature entered by the budget button 63. The user may enter in a total dollar value of the amount of funds they have available for the shopping list 57. As they add items to the list 57 the user is notified when the budget is approached or exceeded. In this way the user can make their shopping experience more efficient by deciding what items they can afford in one shopping trip or may not suggest making a trip until a bottom threshold budget is met. This can avoid the situation where a user cannot afford to purchase all the goods on the list 57 or goes shopping for a small amount of goods making the trip unnecessary and inefficient. Similarly, a budget may be a minimum threshold to initiate a shopping trip. For example, a shopper may not waste time on going out to get ten dollars worth of goods but when the list exceeds a preset amount then it may be worth a run to the store.

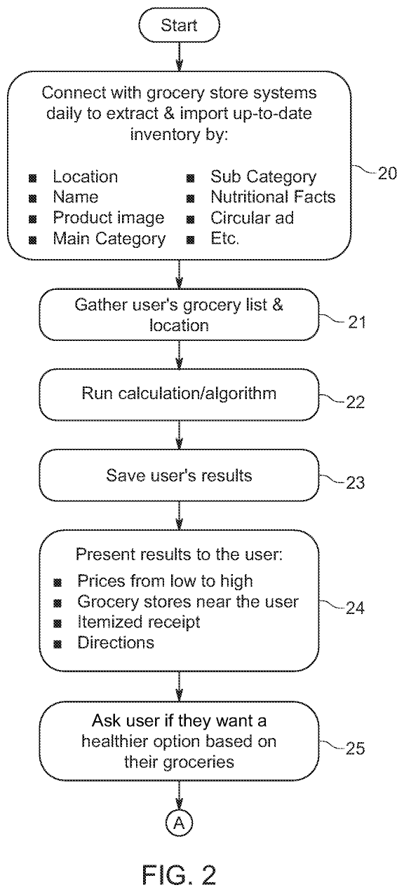

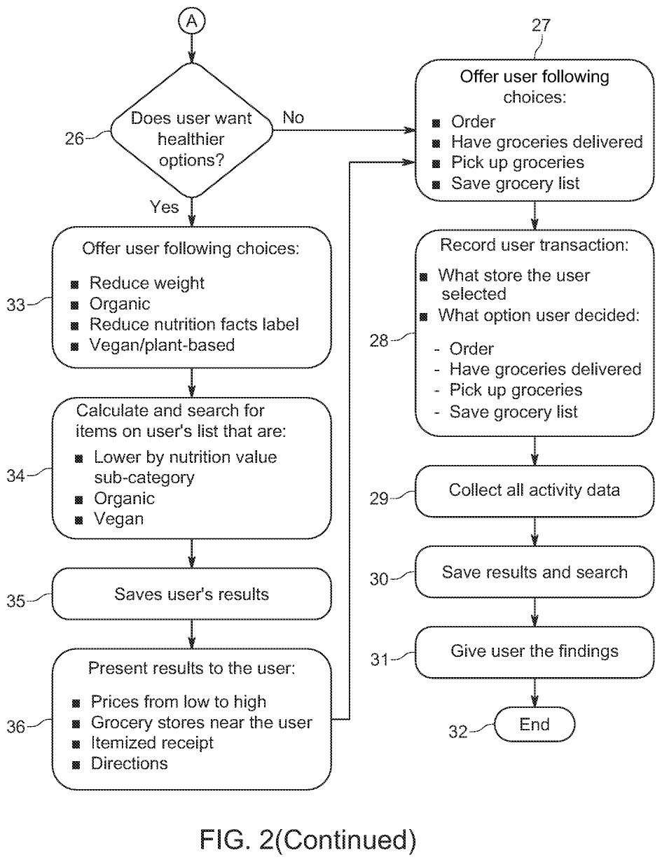

Looking now at FIG. 2 an example of the process is shown in flowchart format. The process starts in step 20 where the system connects to the grocery store systems API on a daily basis to extract and import an up-to-date inventory. The data may include, for example, the location of the product, the name of the product, an image of the particular product, a category of product, nutritional fact information, discounts or promotions or other information relevant to the particular product and retailer.

In step 21 the system then gathers the user's purchasing list 57 and the location of the user. This may also include anticipated locations of the user if they include additional information as described above, such as their home location, work location or other location they may frequent. The location of the user may be derived from GPS coordinates provided by the user's mobile device.

In step 22 the system runs the calculation algorithm retrieving the prices and availability for each of the items on the user's list 57. The results of this computation are saved and associated with the user in step 23.

The results of availability, cost and location of the goods, as well as any associated information, is presented to the user. This may include a way to sort the prices, for example from low to high. Retailers near the user may also be presented and/or displayed on a map along with directions that the user would use to locate that specific retailer. User and shopper terms are used interchangeably.

In step 25 the system it may ask the user if they may be interested in a healthier option for one or more of the goods in their list 57. The healthier option suggestion as shown in the controls 18 and described above, may be automatic or the user may initiate an analysis looking for healthier options of any or all of the goods included for purchase in the list 57.

In step 26 the user decides whether they are interested in a healthier option. If a healthier option is elected step 33 offers the user choices for reducing weight, organic products, nutritionally different products, plant based products or other preferences that the user may have. In step 34 the system calculates and searches for items on the user's list at have a lower nutrition value, are organic or vegetable based. The user's results are saved in step 35. Results are then presented to the user including information such as prices of the goods, retailers merely user, directions of those retailers and an itemized receipt.

If the user declines suggested healthier options the process moves to step 27 where the user is offered options to proceed with the order, have the goods delivered to a preselected location, pick up the groceries or save the grocery list for completion at a later time. In step 28 the system records the user's transaction information, for example including, what store user selected and the options that the user decided to pursue as far as delivery pick up or saving the list for later.

All the activity data of the user is collected in step 29 the results are saved including the search results step 30. And then the user is presented with the findings including a summary of items on the list purchased and the options that the user selected.

Healthier options may be selected by the user to include different ways to be healthier. For example, someone on a low sodium diet may use the healthier option to target or promote items with lower salt content. Similarly, lower fat, lower carbohydrate, higher nutrient, organically sourced, locally grown or any other category can be promoted as a healthier option selected by the user.

The healthier option may also be correlated to the nutritional facts information associated with the products on the list 57. The nutritional facts may then be displayed to the user so they can make a side-by-side comparison and make an informed decision as to whether to proceed with the items on the list 57 as presented or to make a change for products more suited for a healthier user.

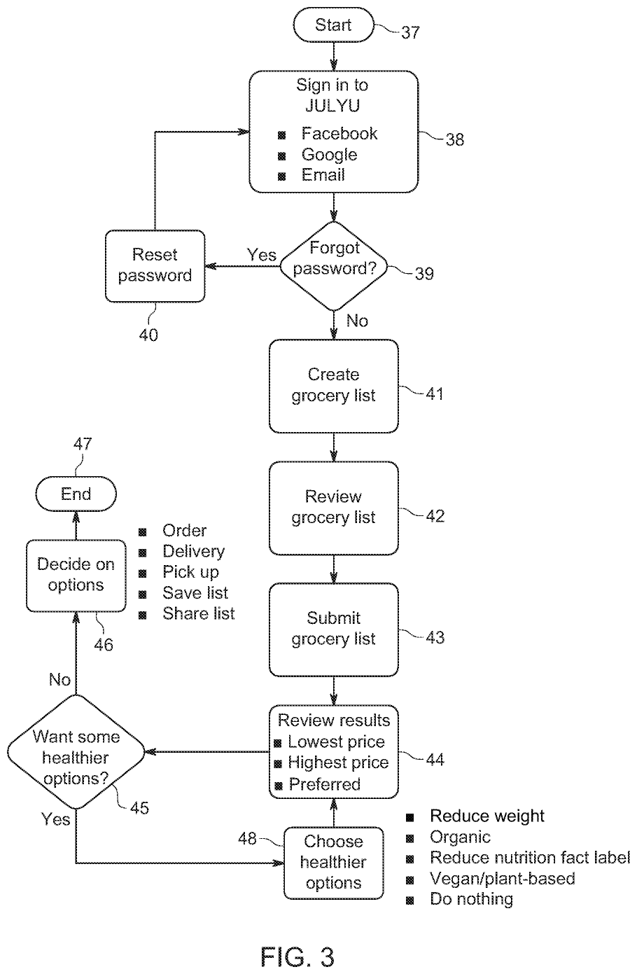

FIG. 3 is an example of a simplified flowchart of the systems processes. The process is initiated at step 37 where the user signs into the system with unique credentials in step 38. These may be shared credentials with other major online entities to ensure the accurate identity of the user. In step 39 if the user forgets their password, the password can be reset in step 40.

Log in credentials are entered the user can create a grocery list in step 41. As noted above, although these examples include retail grocery shopping, the principles described herein of shopping for a complete list and comparing that to the location of retailers is the same for any industry or type of goods.

After the grocery list is created in step 41 the user has an opportunity to review the grocery list in step 42 and submit the grocery list in step 43 to the system. The user may then review the results of the costs of products derived from the grocery stores' API allowing sorting for the highest or lowest price, preferred brands and preferred retailers. In step 45 the user manually requests a review for healthier options or the system automatically is configured to suggest options that may be healthier or better suited to a particular diet.

If the user declines to consider healthier options they may proceed to order the list for delivery or pick up or saving the list or sharing the list in step 46. The process concludes at step 47. However, if the user indicates an interest in healthier options in step 45 they will be able to review and select those healthier options in step 48. After those options are selected, the user may proceed to step 46 and 47 to conclude the transaction as described above.

The efficient shopping app is intended to lower not only a user's cost but also the effort in acquiring groceries. For example, when 20 items are on the user's grocery list, the system compares the total cost of all the items at several local retailers. The user can then consider the cost as well as the location of acquiring those items. Often, the cost difference between different vendors of a weekly shopping list is only a few dollars. However, the time-value of money may offset any savings at a particular retailer.

Although grocery delivery is not required for the essence of the invention, it may be possible that delivery services may participate in the delivery of a complete list. However, when a delivery service takes care of delivering the groceries the time-value of money plays less of the factor because the user of the app is not the one spending the time gathering groceries. However, the user still may benefit by selecting a preferred grocery store after comparing the price of the total list at more than one grocery store.

Many grocery stores and other retailers have an API list containing a wide variety of their goods produced daily or weekly. These API lists are sometimes available at no cost to the app developer, but others are available on a paid subscription basis. The app developer may then incorporate the API information from a variety of different retailers.

The healthier option feature, described above, may also use the government published nutritional facts on individual products. The app may then calculate a cumulative total of calories, carbohydrates, saturated fat or other nutritional data when suggesting to a user a healthier option.

The app may calculate the total sum of these nutritional elements in an entire list to get a better picture of the healthiness of a user's diet. This can be used to steer a user of the app into healthier options by informing them of the nutritional content of their entire list.

When the using the budget option, described above, the user may indicate they have a certain budget to spend on the items on their list. For example, a user may have a fifty dollar budget and enter that information into the system. The application will then be able to guide the user to a retail location where they may be able to get the most items on their list and still remain under budget. Of course, this may be merged with the mapping feature to show the location of the identified retailers so the user can consider the time required to travel to and acquire all the items on the list.

One optional feature of the software includes an ability to share the shopping list. For example, the items on the list may be shared with family members so that each can contribute to purchasing the items on the list. Similarly, the family member responsible for grocery shopping and cooking may share a list with another family member who happens to be traveling in a location near other retailers. This may make it convenient for someone other than who created the list to pick up the groceries.

In another version of the invention the software may have limits of what can be purchased to comply with regulations for government assisted nutrition programs. For example, the application may be pre-loaded onto a government phone and that limits the purchase of restricted items, such as alcohol, tobacco or other items prohibited to be purchased while on a government program.

Another key advantage of the software is that it allows a user to consolidate a list so their entire shopping can be completed at one retail store instead of having to go to several different stores to complete the purchase of all items on the list.

If items are not available, the system may flag the item as missing to alert the user that they may not be able to complete the purchase of all items on the shopping list at a particular retailer. If an item is not available at one retailer, that item may be removed from the total cost calculation applied to other retailers so that the retailers can be evaluated evenly for completing a list where all items can be purchased.

The application may save the list to aid in pre-populating the next list of groceries to purchase. The predictive nature of this may be based on prior purchases of that particular user or may be generated by artificial intelligence by evaluating a broad cross-section of users. For example, a generic user that buys wine and grapes may also frequently be interested in also purchasing cheese or olives. Or, a for user who frequently purchases ice cream, the app may suggest ice cream cones or chocolate sauce to ensure nothing is missed.

The system optionally may utilize the optical sensor or camera in a personal hand-held device to scan optical codes or other wireless data connections. For example, a user may scan a code in a magazine for a recipe causing the system to populate the list with the ingredients for the recipe. Similarly, the user may scan a coupon for discounts that may be automatically applied to the shopping list.

In one version of the invention the system will default to the lowest cost alternative that complies with the item on the list. For example, if no brand is selected the system will automatically select the lowest cost option. This may be a store brand or item on sale. If specific brands or features of a product are selected, that will override any default. However, the system may also make a suggestion that there are similar products available at a lower price.

An important feature of the efficient shopping is that there should be at least two items in the virtual shopping cart or list as well as at least two retail stores at which the list will be compared. This contrasts from current art where either one item is shopped at multiple stores or the user puts all items from the list in one virtual shopping cart at one retailer. The user then has the ability, based in part on the total cost of purchasing the entire list, balanced with the location of the retailers that can provide all the products on the list, to make an informed decision as to where to shop and buy all items on the list.

An important version of the invention can be fairly described as a process for selecting and efficient retailer comprising the steps of providing a software application that is accessible on a computing device such as a desktop computer, mobile phone, tablet or other network connected device. When the shopper logs onto the system with their unique ID they compile a list that has at least two items to be purchased by the user. The application identifies a geographical region where the shopper and the potential retailers are located. This limits the available retailers to those that are likely to be preferred by the shopper. The shopper may add or subtract retailers or the region as they desire and see fit. The user selects at least two potential retailers that are in the geographic region for analysis. The after retrieves information associated of each item on the list that includes the price of the item. Other information may also be collected such as nutritional information, discounts and coupons, product availability or any other information specific to those products on the list. The application then adds the price for all items on the list to get a total cost to purchase the entire list from each potential retailer individually. In this way the shopper is presented a total amount to purchase all items on the list from each retailer so that they can compare the total cost for completing the shopping list and analyze that along with the location of the retailer to determine the most convenient and therefore efficient place to purchase the items on their list. This information about pricing and location is provided in a human understandable format such as the written or spoken word with or without graphical cues of such as images of the item being purchased, maps, coupons, sounds or other means to interact with a human. With or without the aid of the human the system evaluates the location of each potential retailer to identify which would be the most efficient retailer from the several selected potential retailers to purchase all the items on the list taking into account both the total cost of purchasing the list and the location of each potential retailer relative to the location of the shopper derived from the location of their computing device.

Any of the following optional features may be included individually or altogether to improve the functionality of the process. Optionally, the location of the computing device (where the shopper is then located) and the locations of the potential retailers are plotted on a map to aid in visually determining which may be the most efficient retailer at which to shop. Optionally, the system may include a feature to automatically analyze the publicly available nutritional information from any item on the list and provide a suggestion for a healthier option to replace that item on the list. For example, if a user includes regular ice cream on the list, the system it may suggest a lower calorie alternative. Optionally, individual items or an entire shopping list may be populated by entering or scanning a code with the computing device. For example, a recipe code can be scanned to add all the ingredients for making that recipe. Optionally, if an item on the list is not available from any of the potential retailers that item may be flagged for further evaluation or removed from the list to ensure that the total cost to purchase all the goods from the retailers considers the available products. Optionally, the list may be partially or totally productively populated based on previous purchasing patterns by a particular user the system.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A process for selecting an efficient retailer comprising:
providing a computing device operating an application;
compiling at least two items onto a list in the application;
identifying a geographic region in the application;
identifying a location of the computing device from a GPS signal;
selecting at least two retailers from within the geographic region;
retrieving an information published from each retailer comprising a price associated with each item on the list;
adding the price of all items on the list from each retailer individually;
providing in a human understandable visual format on the computing device a total cost to purchase all the items on the list from each retailer individually;
evaluating the total cost of the list at each retailer and evaluating a location of each retailer to identify the efficient retailer from the retailers from which to purchase all items on the list accounting for both the total cost at each retailer and the location of each retailer relative to the location of the computing device;
the process additionally including at least 12 of the following additional features:
a. the application defines the geographic region to include a home location and a work location derived from the location of the computing device;
b. the information published from each retailer further includes a coupon that reduces the cost of at least one item on the list;
c. the computing device displays in a human readable format a nutritional information from a government agency for at least one item on the list;
d. the application defines the geographic region to include a geographical location of a third party to which the items on the list will be delivered;
e. for at least one item on the list providing an option associated with that item of at least one of: a brand, a size and a variety;
f. the computing device includes a scanner that reads a code associated with a specific product to add the specific product to the list;
g. when a meal prep selection is made on the computing device multiple items are added to the list automatically corresponding to a preselected ingredient list;
h. competing product is suggested for at least one item on the list;
i. a healthier option product is suggested as an alternative for at least one items on the list;
k. for at least one item on the list providing a suggested alternative for that one item having any of: a lower sodium content, a lower fat content, a higher nutritional content, being organic and being locally sourced;
l. the computing device displays side-by-side a nutritional facts information of at least two items on the list;
m. the computing device receives and adds to the list a second item from a second computing device;
n. the application does not allow items that contain alcohol or nicotine to be added to the list;
o. the application pre-populates a new list with items that were on an earlier list;
Q. the application prepopulates the list with items selected by artificial intelligence evaluating other users of the application.

2. (canceled)

3. (canceled)

4. (canceled)

5. (canceled)

6. (canceled)

7. (canceled)

8. A process for selecting an efficient retailer comprising:
providing a computing device operating an application;
compiling at least two items onto a list in the application;
identifying a geographic region in the application;
identifying a location of the computing device from a GPS signal;
selecting at least two retailers from within the geographic region;
retrieving an information comprising a price associated with each item on the list;
adding the price of all items on the list from each retailer individually;
providing in a human understandable visual format a total cost to purchase all the items on the list from each retailer individually;
evaluating the total cost of the list at each retailer and evaluating a location of each retailer to identify the efficient retailer from the retailers from which to purchase all items on the list accounting for both the total cost at each retailer and the location of each retailer relative to the location of the computing device;
each retailer and the location of the computing device are plotted and displayed on a map on the computing device when evaluating the retailer to identify the efficient retailer;
the application analyzes a nutritional information from an item on the list and provides a suggested healthier option to replace that item on the list;
list is populated by entering or scanning a code; and
if an item on the list is not available at any one of the retailers then that item is flagged on the list;
the process additionally including at least fifteen of the following additional features:
a. the application defines the geographic region to include a home location and a work location derived from the location of the computing device;
b. the information published from each retailer further includes a coupon that reduces the cost of at least one item on the list;
c. the computing device displays in a human readable format a nutritional information from a government agency for at least one item on the list;
d. the application defines the geographic region to include a geographical location of a third party to which the items on the list will be delivered;
e. for at least one item on the list providing an option associated with that item of at least one of: a brand, a size and a variety;
f. the computing device includes a scanner that reads a code associated with a specific product to add the specific product to the list;
g. when a meal prep selection is made on the computing device multiple items are added to the list automatically corresponding to a preselected ingredient list;
h. competing product is suggested for at least one item on the list;
i. a healthier option product is suggested as an alternative for at least one item on the list;
k. for at least one item on the list providing a suggested alternative for that one item having any of: a lower sodium content, a lower fat content, a higher nutritional content, being organic and being locally sourced;
l. the computing device displays side-by-side a nutritional facts information of at least two items on the list;
m. the computing device receives and adds to the list a second item from a second computing device;
n. the application does not allow items that contain alcohol or nicotine to be added to the list;
o. the application pre-populates a new list with items that were on an earlier list;
q. the application prepopulates the list with items selected by artificial intelligence evaluating other users of the application.

9. (canceled)

10. (canceled)

11. (canceled)

12. (canceled)

13. (canceled)

14. (canceled)

15. (canceled)

16. (canceled)

17. (canceled)
